(19) United States
(12) Patent Application Publication
(10) Pub. No.: US 2021/0337747 A1
(43) Pub. Date: Nov. 4, 2021

(54) Kachina Aholi

(71) Applicant: Yhsh Ellis, San Antonio, TX (US)

(72) Inventor: Yhsh Ellis, San Antonio, TX (US)

(21) Appl. No.: 16/714,741

(22) Filed: Dec. 15, 2019

(51) Int. Cl. A01G 15/00; B01D 46/00; B01D 39/14; B64C 27/04; B64D 1/18

(52) U.S. Cl. CPC A01G 15/00; B01D 46/0035; B01D 39/14; B01D 2239/0478; B64D 1/18; B01D 2239/0428; B64C 27/04

(57) ABSTRACT

The Kachina Aholi is a device invented out of three main components. The three components are: a drone or other aerial load lifting apparatus, a air filter (varying in the passage intensity of molecular material, graded filters) and a Super or Ultra hydrophobic spray (e.g. WATERBEADER™). These three components combined make a device that is flown up to clouds that are dense with water molecules and “bead” those molecules up along the air filter and cause premature precipitation. This method of premature precipitation can be used to irrigate farms, prevent flash floods, prevent landslides, wildfire prevention or reduction, increase accessibility in low water/dry areas, and climate control.

This invention can be used in many different ways. The first envisionment is safety.

Wildfires are started in the heat and when drought conditions peak. During those times, this invention can be used to moisten problem areas that have risk factors that cause wildfires or forest fires. Projected droughts can be managed to prevent loss of life and vegetation. In the right conditions this invention can help put out fires as well. Another safety use for this invention is the prevention of flash floods or mudslides. Flash floods are created when excessive precipitation reaches low level land areas. Mudslides are created when excessive precipitation reaches loose sediment on mountain ranges and hills. This invention can drain predicted storms and clouds before they reach these areas to prevent the catastrophe.

The second envisionment of use is water transportation and preservation. Millions of gallons of fresh water is rained out over the ocean right off the coast. This invention can drain the clouds of fresh water before the clouds drift out to sea. This invention would have to be used in tandem with water reservoirs and water processing plants, Additionally, farming communities can use this invention to irrigate their crops in a more customized way by eliminating the functional restrictions of mechanical dispersion methods. Water transportation methods can be costly and dangerous. This invention can reduce those risks and cost by using the earth's natural water cycle and weather patterns.

The third envisionment of use is Custom Climates. This invention used in tandem with the cloud producing process can create privatized climates based on location and water amounts. Clouds consist of water, which is a molecule consisting of two hydrogen atoms and one oxygen atom. The most known way to make a cloud would be through evaporation process in the natural water cycle. If one makes clouds through the process of evaporation, then uses this invention to drain the clouds over a particular area repeatedly, gradually, one can create custom climates in that area. This invention could create an oasis of water every 20 miles across any desert with the proper instruction and care of use. (The best example of this process would be Operation Popeye by the US government. During the Vietnam War the US government increased the amount of water in Vietnam by dumping more water than was in their natural water cycle. The results of this action concluded in an increase of their rainy season from 7 months to 12 months.) This process was later outlawed by the UN for the weaponization of weather. However, in tandem with this invention, instead of weaponizing the weather we can use the weather to our advantage.

The final use for this invention is a on a global scale. Global Warming is causing sea levels to rise everywhere. This use would take a massive cooperation across many countries and the use of many experts in the meteorology. If this cooperation were to take place we could save the areas that are at risk of becoming sunken under the sea by keeping the water cycle over land instead of the sea.

1. In this claim I will be detailing my invention called the Kachina Aholi. In the broadest of terms, my invention is a device that can prematurely precipitate clouds. My device can cause clouds to rain before they are predicted to rain.
The starting component of my invention consist of a normal air filter that one can find at any general store that is used for house-hold air conditioning filtering. Next the air filter is sprayed in its entirety with a product called WATER BEADER. This substance is a super hydrophobic spray that is used for materials from fabrics to cement. Its purpose is to create a hydrophobic coating on your materials. The purpose of this product on my device is to enhance the air filter to “bead” up the microscopic water droplets in mid level to low level clouds that the air filter comes in contact with. The hydrophobic spray can vary from SUPERhydrophobic to ULTRA hydrophobic. The more hydrophobic, the better the results will be for causing the premature precipitation. This “beading” process will cause the water droplets to gain weight, then gravity will cause the droplets to fall. This component can be sophisticatedly upgraded to a material that allows air flow through it but does not allow microscopic water droplets through. A detailed description of an upgraded material: Mesh material that has microscopic airflow that can cause microscopic water droplet molecules to group together to make larger water droplets without going through the mesh material. The size of these filters or mesh can vary due to the needs that will be expressed later in this claim. Allow a method for drainage, by placing holes at the bottom of the filter or mesh the droplets can fall from the device. Next in the process is to get the hydrophobic air filter or mesh to mid level clouds or low level clouds. By attaching the hydrophobic air filter or mesh to a helicopter or plane, one can fly this invention through clouds to “bead” water droplets together to make the droplets bigger in size. The plane or helicopter would have to start at the top of the cloud and allow the new “beaded” droplets to fall down into the lower part of the cloud. The “beaded” droplets would fall and collect the water droplets below it causing it to get bigger. I call this process the squeegee effect. (When using a squeegee to clear a flat surface of water, the squeegee “bunches” the water up at the end of your squeegee stroke and you will see a stream of the collected water fall down, because of gravity, and start to collect more of the water you have yet to squeegee on its way down. This process will make the cloud rain more efficiently below the aircraft due to gravity and weight.) Different flight patterns and maneuvers will cause the clouds to drain in different ways depending on the purpose of use.
